(19) United States
(12) Patent Application Publication
(10) Pub. No.: US 2014/0172415 A1
(43) Pub. Date: Jun. 19, 2014

(54) APPARATUS, SYSTEM, AND METHOD OF PROVIDING SENTIMENT ANALYSIS RESULT BASED ON TEXT

(71) Applicant: Electronics and Telecommunications Research Institute, Daejeon (KR)

(72) Inventor: Yohan JO, Seoul (KR)

(73) Assignee: Electronics and Telecommunications Research Institute, Daejeon (KR)

(21) Appl. No.: 13/945,290

(22) Filed: Jul. 18, 2013

(30) Foreign Application Priority Data
Dec. 17, 2012 (KR) 10-2012-0147545

(51) Int. Cl. G06F 17/27

(52) U.S. Cl. CPC G06F 17/2785
USPC 704/9

(57) ABSTRACT

Disclosed are an apparatus, a system, and a method of providing a sentiment analysis result based on a text. An apparatus for providing a sentiment analysis result based on a text according to the present invention includes: an input unit configured to receive a keyword for a target for which a sentiment is desired to be analyzed from a user; a control unit configured to request a sentiment analysis for the received keyword to a service server and receive a sentiment analysis result as a result of the request; a display unit configured to display an attribute for the target according to the received sentiment analysis result, and display a text corresponding to an attribute value for each displayed attribute; and a storage unit configured to store the received sentiment analysis result.

### CROSS-REFERENCE TO RELATED APPLICATIONS

This application claims priority to and the benefit of Korean Patent Application No. 10-2012-0147545 filed in the Korean Intellectual Property Office on Dec. 17, 2012, the entire contents of which are incorporated herein by reference.

### TECHNICAL FIELD

The present invention relates to a sentiment analysis method, and more particularly, an apparatus, a system, and a method of providing a sentiment analysis result based on a text, which receives a target keyword from a user to search for a text, such as a sentence or writing, including the received target keyword, and calculates a sentiment analysis result for each attribute of the target keyword based on the searched text, in which the sentiment analysis result is calculated based on a learning result calculated based on a previously learned result.

### BACKGROUND ART

An analysis of a sentiment (feeling and opinion) represented in a text for each attribute of a target or for each evaluation item means an analysis of sentiments represented for a detailed attribute or evaluation item, not a general sentiment for the target. For example, when there is a text for a certain restaurant, a sentiment for detailed attributes of the restaurant, for example, a price, atmosphere, and services, is analyzed.

Analysis methods in the related art generally have a limitation in that a processible sentiment analysis is limited to expressions directly represented in a learning corpus.

For example, in a case where a learning corpus for a notebook computer includes an expression of “the screen is too glossy”, but does not include an expression of “the display is too glossy”, even though the “screen” and the “display” indicate the same attribute, it is difficult to analyze a sentiment for the expression of “the display is too glossy”. In a case where the learning corpus includes an expression of “the screen is too glossy”, but does not include an expression of “the screen reflects”, even though it is recognized that the former represents a “disappointing” sentiment, it is difficult to analyze a sentiment for the latter.

### SUMMARY OF THE INVENTION

The present invention has been made in an effort to provide an apparatus, a system, and a method of providing a sentiment analysis result based on a text, which receives a target keyword from a user to search for a text, such as a sentence or writing, including the received target keyword, and calculates a sentiment analysis result for each attribute of the target keyword based on the searched text, in which the sentiment analysis result is calculated based on a learning result calculated based on a previously learned result.

However, an object of the present invention is not limited to the aforementioned matters, and those skilled in the art will clearly understand non-mentioned other objects through the following description.

An exemplary embodiment of the present invention provides an apparatus for providing a sentiment analysis result based on a text, the apparatus including: an input unit configured to receive a keyword for a target, for which a sentiment is desired to be analyzed, from a user; a control unit configured to request a sentiment analysis for the received keyword to a service server and receive a sentiment analysis result as a result of the request; a display unit configured to display an attribute for the target according to the received sentiment analysis result, and display a text corresponding to an attribute value for each displayed attribute; and a storage unit configured to store the received sentiment analysis result, in which the attribute is a detailed item for evaluating the target of the sentiment or expressing the sentiment, and the attribute value is an expression for evaluating the attribute or representing the sentiment for the attribute.

The display unit may display the attribute for the target, display a plurality of sentiments for each displayed attribute, and display a text corresponding to the attribute value for each displayed sentiment.

The display unit may display a text corresponding to the attribute value for each sentiment, and display attribute expressions and attribute values serving as a determination reference for analyzing the sentiment while emphasizing the attribute expressions and the attribute values by using at least one of a color, an underline, and a highlight so that the attribute expressions and the attribute values are discriminated within the text.

The display unit may display a text corresponding to the attribution value for each sentiment, and calculate a point by using a numerical value previously assigned to each of the attribution expressions and the attribute values serving as the determination reference for analyzing the sentiment, and determine a corresponding sentiment to which each of the texts belongs based on the calculated point.

Another exemplary embodiment of the present invention provides a system for providing a sentiment analysis result based on a text, the apparatus, the system including: a service server configured to search for a text including a keyword for a target, for which a sentiment is desired to be analyzed, received from a user terminal, calculate a sentiment analysis result for each attribute for the target from the searched text based on a previously learned learning result, and provide the calculated sentiment analysis result to the user terminal; and a database configured to store a learning result including an attribute expression set and an attribution value set calculated from a previously collected learning text, in which the attribute is a detailed item for evaluating the target of the sentiment or expressing the sentiment, the attribute expression set represents a set of attribute expressions which are detailed expressions used for indicating the attribute, and the attribute value set represents a set of attribute values which are expressions for evaluating the attribute or representing a sentiment for the attribute.

The service server may include: a search unit configured to search for a text including the keyword for the target for which the sentiment is desired to be analyzed; an extraction unit configured to extract an attribute expression and attribute values from the text based on the previously learned learning result; and an analysis unit configured to calculate a sentiment analysis result for the keyword based on the extracted attribute expression and attribute values, and the learning result, and provide the user terminal with the calculated sentiment analysis result.

The analysis unit may identify whether the extracted attribute expression and attribute values are included in the attribute expression set and the attribute value set of the learning result, and determine an attribute and a sentiment corresponding to the attribute expression set and the attribute value set of the learning result as the attribute and the sentiment of the extracted attribute expression and attribute values according to a result of the identification.

The service server may include: a collection unit configured to previously collect a plurality of learning texts for learning; an extraction unit configured to extract an attribute expression and attribute values included in the previously collected learning text; and a learning unit configured to perform learning for the analysis of the sentiment by using the extracted attribute expression and attribute value, and generate the learning result with a result of the learning.

The learning result may include a set of the attribution expressions, a set of the attribute values, a numerical value assigned to the attribute expression and the attribute value of every combinable attribute pair, and a method capable of calculating a point by using a numerical value assigned to the combinable attribute expression and attribute value.

Yet another exemplary embodiment of the present invention provides a method of providing a sentiment analysis result based on a text, the method including: receiving a keyword for a target, for which a sentiment is desired to be analyzed, from a user; requesting a sentiment analysis for the received keyword to a service server and receiving a sentiment analysis result as a result of the request; displaying an attribute for the target according to the received sentiment analysis result, and displaying a text corresponding to an attribute value for each displayed attribute; and storing the received sentiment analysis result, in which the attribute is a detailed item for evaluating the target of the sentiment or expressing the sentiment, and the attribute value is an expression for evaluating the attribute or representing the sentiment for the attribute.

The displaying may include displaying the attribute for the target and displaying a plurality of sentiments for each displayed attribute, and displaying a text corresponding to the attribute value for each displayed sentiment.

The displaying may include displaying a text corresponding to the attribute value for each sentiment, and displaying attribute expressions and attribute values serving as a determination reference for analyzing the sentiment while emphasizing the attribute expressions and the attribute values by using at least one of a color, an underline, and a highlight so that the attribute expressions and the attribute values are discriminated within the text.

The displaying may include displaying a text corresponding to the attribution value for each sentiment, and calculating a point by using a numerical value previously assigned to each of the attribution expressions and the attribute values serving as the determination reference for analyzing the sentiment, and determining a corresponding sentiment to which each of the texts belongs based on the calculated point.

Still another exemplary embodiment of the present invention provides a method of providing a sentiment analysis result based on a text, the method including: storing a learning result including an attribute expression set and an attribution value set calculated from a previously collected learning text; searching for a text including a keyword for a target, for which a sentiment is desired to be analyzed, received from a user terminal; and calculating a sentiment analysis result for each attribute for the target from the searched text based on the previously learned learning result and providing the user terminal with the calculated sentiment analysis result, in which the attribute is a detailed item for evaluating the target of the sentiment or expressing the sentiment, the attribute expression set represents a set of attribute expressions which are detailed expressions used for indicating the attribute, and the attribute value set represents a set of attribute values which are expressions for evaluating the attribute or representing a sentiment for the attribute.

The providing may include extracting an attribute expression and attribute values from the text based on the previously learned learning result, and calculating a sentiment analysis result for the keyword based on the extracted attribute expression and attribute values, and the learning result, and providing the user terminal with the calculated sentiment analysis result.

The providing includes identifying whether the extracted attribute expression and attribute values are included in the attribute expression set and the attribute value set of the learning result, and determining an attribute and a sentiment corresponding to the attribute expression set and the attribute value set of the learning result as the attribute and the sentiment of the extracted attribute expression and attribute values according to a result of the identification.

The storing may include previously collecting a plurality of learning texts for learning and extracting an attribute expression and attribute values included in the previously collected learning text, and performing learning for the analysis of the sentiment by using the extracted attribute expression and attribute values, generating the learning result with a result of the learning, and storing the generated learning result.

The learning result may include a set of the attribution expressions, a set of the attribute values, a numerical value assigned to the attribute expression and the attribute value of every combinable attribute pair, and a method capable of calculating a point by using a numerical value assigned to the combinable attribute expression and attribute value.

According to the exemplary embodiments, the present invention receives a target keyword from a user to search for a text, such as a sentence or writing, including the received target keyword, and calculate a sentiment analysis result for each attribute of the target keyword based on the searched text, in which the sentiment analysis result is calculated based on a learning result calculated based on a previously learned learning result, thereby achieving an effect of diversifying expressions on which the sentiment analysis may be performed.

The present invention suggests a point corresponding to a sentiment for each attribute for a target keyword as a result of the sentiment analysis, thereby achieving an effect of suggesting subjectivity for the result of the sentiment analysis.

The present invention displays a part of a text based on which a sentiment for each attribute for a target keyword is determined as a result of a sentiment analysis, thereby achieving an effect of suggesting a basis for the result of the sentiment analysis.

The present invention suggests a basis and a point based on which a sentiment for each attribute for a target keyword is determined as a result of a sentiment analysis, thereby achieving an effect of improving reliability for the result of the sentiment analysis.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram schematically illustrating a system for providing a sentiment analysis result based on a text according to an exemplary embodiment of the present invention.

FIG. 2 is a diagram illustrating a detailed configuration of a user terminal according to an exemplary embodiment of the present invention.

FIG. 3 is a diagram illustrating a detailed configuration of a service server according to an exemplary embodiment of the present invention.

FIG. 4 is a diagram for describing a principle of extracting an attribute expression and an attribute value according to an exemplary embodiment of the present invention.

FIG. 5 is a diagram illustrating one form of a learning result for a sentiment analysis according to an exemplary embodiment of the present invention.

FIG. 6 is a diagram illustrating another form of a learning result for a sentiment analysis according to an exemplary embodiment of the present invention.

FIG. 7 is a diagram for describing a process of a sentiment analysis according to an exemplary embodiment of the present invention.

FIG. 8 is a diagram illustrating a screen displaying a sentiment analysis result according to an exemplary embodiment of the present invention.

FIG. 9 is a flowchart illustrating a method of providing a sentiment analysis result according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

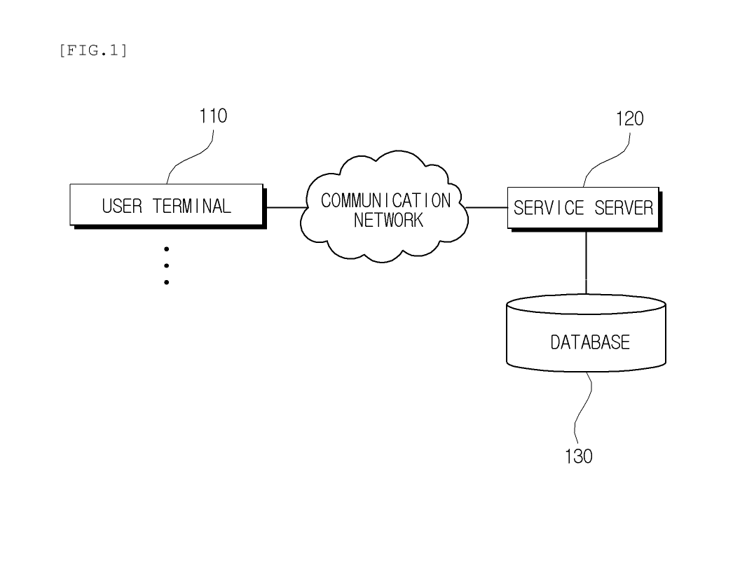

Hereinafter, an apparatus, a system, and a method of providing a sentiment analysis result based on a text according to an exemplary embodiment of the present invention will be described with reference to FIGS. 1 to 9. The present invention will be described in detail based on parts necessary to understand an operation and an effect according to the present invention.

In describing constituent elements of the present invention, different reference numbers may refer to like elements depending on the drawing, and like reference numerals may refer to like elements even though like elements are shown in different drawings. However, even in this case, it is not meant that a corresponding constituent element has a different function according to an exemplary embodiment or has the same function in different exemplary embodiments, and a function of each constituent element may be determined based on a description of each constituent element in a corresponding exemplary embodiment.

Especially, the present invention suggests a new method of receiving a target keyword from a user to search for a text, such as a sentence or writing, including the received target keyword, and calculating a sentiment analysis result for each attribute of the target keyword based on the searched text, in which the sentiment analysis result is calculated based on a learning result calculated based on a previously learned result.

FIG. 1 schematically illustrates a system for providing a sentiment analysis result based on a text according to an exemplary embodiment of the present invention.

As illustrated in FIG. 1, a system for providing a sentiment analysis result based on a text according to the present invention may include a user terminal 110, a service server 120, a database 130, and the like.

The user terminal 110 may activate a web browser or a dedicated application according to an operation of a menu item or a key by a user, access the service server through the activated web browser or dedicated application, requests for a sentiment analysis for a received target keyword to the accessing service server, and receive a sentiment analysis result for each attribute for the target keyword as a result of the request.

Here, the target keyword may be a concept collectively including a keyword indicating a product, a person, a policy, and the like.

The service server 120 may search for a sentence or writing including a target keyword and calculate a sentiment analysis result for each attribute of the target keyword from the searched text, such as a sentence or writing, based on a previously learned learning result.

The database 130 may store an attribute, an attribute expression, an attribute value, an attribute pair, and the like.

Here, 1) the attribute may represent a detailed item for evaluating or expressing a sentiment for a target of a sentiment, for example, when the target for the sentiment is a restaurant, the attribute may represent “a price”, “atmosphere”, “services”, and the like.

2) The attribute expression may represents a detailed expression used for indicating a certain attribute, for example, “a price”, “a food price”, “a value”, and the like for indicating the attribute of “price” of a restaurant.

3) The attribute value may represent an expression for evaluating the attribute or indicating a sentiment for the attribute, for example, “expensive”, “cheap”, and the like” for the attribute of “price” of a restaurant.

4) The attribute pair may be expressed with a pair of the attribute expression and the attribute value aforementioned in 2) and 3), that is {attribute expression, attribute value}, for example, {food price, expensive}.

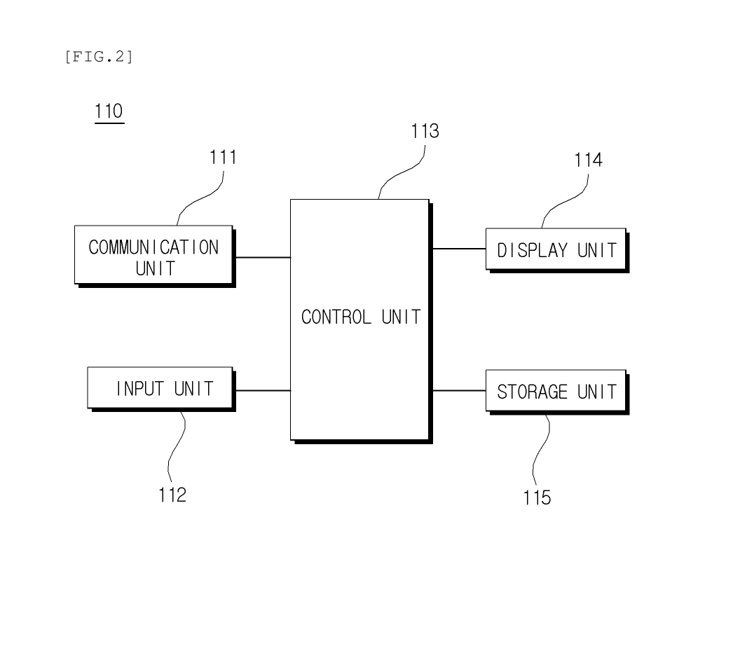

FIG. 2 illustrates a detailed configuration of the user terminal according to the exemplary embodiment of the present invention.

As illustrated in FIG. 2, the user terminal 110 according to the present invention may include a communication unit 111, an input unit 112, a control unit 113, a display unit 114, and a storage unit 115.

The communication unit 111 may transmit or receive various data in association with the service server 120 through wired communication or wireless communication. For example, the communication unit 111 may receive a sentiment analysis result for each attribute of a specific target keyword, for which a sentiment is desired to be analyzed, from the service server 120.

The input unit 112 may receive information according to an operation of a menu item or a key by the user.

The control unit 113 may activate a web browser or a dedicated application according to an operation of a menu item or a key by the user, request a sentiment analysis for a target keyword received from the activated web browser or dedicated application to the service server 120, and receive a sentiment analysis result for each attribute for the target keyword as a result of the request.

The display unit 114 may receive a specific target keyword, for which a sentiment is desired to be analyzed, from the user through a web browser or a dedicated application, and display a sentiment analysis result for each attribute of the received target keyword.

The display unit 114 may display the sentiment analysis result for each attribute of the received target keyword, and may display the attribute for the target and display a text, such as a sentence or writing, corresponding to an attribute value for each displayed attribute.

The storage unit 115 may store a sentiment analysis result for each attribute of a received target keyword.

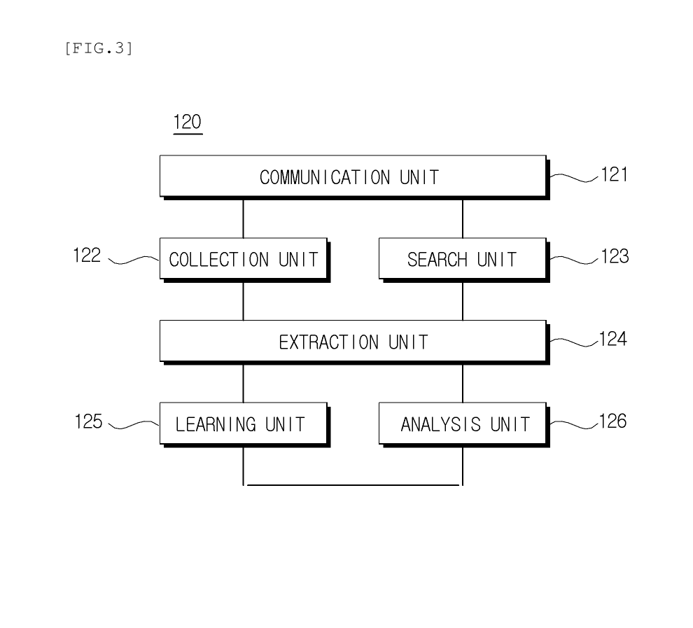

FIG. 3 illustrates a detailed configuration of the service server according to the exemplary embodiment of the present invention.

As illustrated in FIG. 3, the service server 120 according to the present invention may include a communication unit 121, a collection unit 122, a search unit 123, an extraction unit 124, a learning unit 125, and an analysis unit 126.

The communication unit 121 may transmit or receive various data in association with the user terminal 110 through wired communication or wireless communication. For example, the communication unit 121 may transmit a sentiment analysis result for each attribute of a specific target keyword, for which a sentiment is desired to be analyzed, to the user terminal 110.

The collection unit 122 may previously collect a text, that is, a learning text, such as a sentence or writing, for learning.

The extraction unit 124 may extract the attribute expression and the attribute values included in the previously collected learning text for learning. A method of extracting the attribute expression and the attribute values is various.

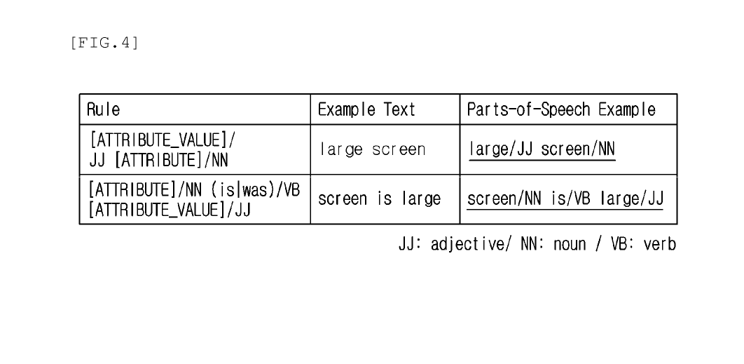

FIG. 4 is a diagram for describing a principle of extracting an attribute expression and an attribute value according to the exemplary embodiment of the present invention.

As illustrated in FIG. 4, one method of extracting an attribute expression and an attribute value is to extract of an attribute pair by using a predetermined rule. For example, a rule in the unit of a morpheme indicating an attribute pair is created, and the created rule is matched to a text.

The rule “[ATTRIBUTE]/NN (is|was)/VB [ATTRIBUTE_VALUE]/JJ” means that when a pattern of “noun+verb (“is” or “was”)+adjective” is represented in a text, a noun part is determined as the attribute and an adjective part is determined as the attribute value.

For example, a text of “the screen is large” is formed of a morpheme of “the/DT screen/NN is/VB large/JJ”, and the aforementioned rule is matched thereto, so that {“screen”, “large”} is extracted.

A rule using a dependency relation may also be used in addition to the rule using the morpheme. Otherwise, a rule may be set by using a regular expression directly for a text. As described above, the attribute expression and the attribute value are extracted in a form of the attribute pair, but are not essentially limited thereto, and may be extracted in various forms according to a learning method.

The learning unit 125 may perform learning for a sentiment analysis by using the extracted attribute expression and attribute value, and generate a learning result with a result of the learning. Here, the learning result includes 1} a set of attribute expressions used for indicating attributes for respective attributes, 2) a set of attribute values for representing a sentiment for respective sentiments, 3) information based on which a score for every combinable attribute pair may be calculated, 4) a metric based on which a score for every combinable attribute pair may be calculated, and the like.

Here, the information represents a point assigned to each of the attribute expression and the attribute value of the attribute pair, and the metric indicates a method calculating a score for the attribute pair by using the assigned points.

In this case, the learning method includes various methods, such as a learning method using a clustering method and a learning method using a statistical method, and the learning method using the statistical method among them will be described.

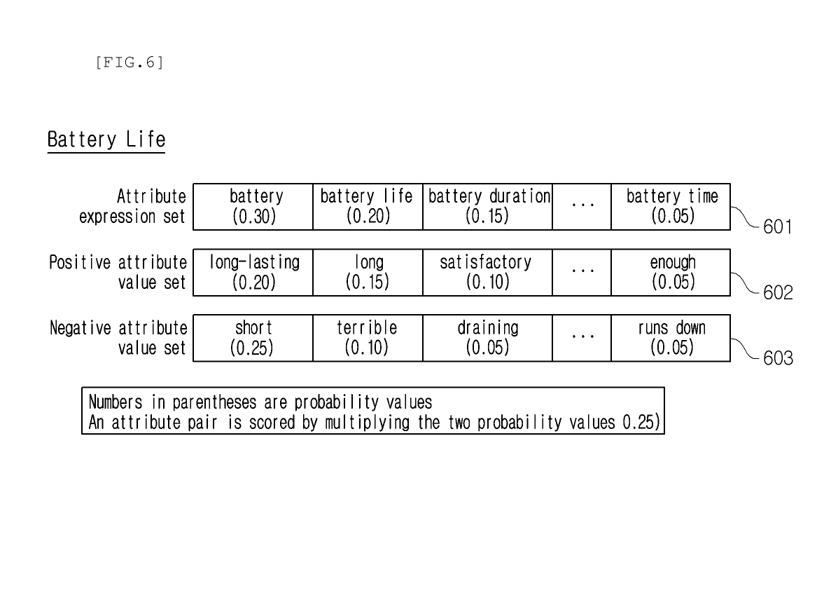

A numerical value having a statistical meaning is assigned to each of the expressions included in the set of the attribute expressions. As one example, each attribute expression may be assigned the ratio of this attribute expression being used to indicate the corresponding attribute in text. For example, referring to FIG. 6, in the case of indicating the attribute of “battery life” in the text, when the ratio of the expression “battery” being used is 0.30 and the ratio of the expression “battery duration” being used is 0.15, 0.30 and 0.15 are assigned to these two expressions, respectively.

The numerical value of the statistical meaning may be variously assigned, other than a simple frequency ratio. Similarly, a numerical value having a statistical meaning is assigned to each expression even in a set of attribute values for each sentiment. Then, when a score for a combination of certain two expressions, that is, one attribute expression and one attribute value, is calculated, two numerical values may be multiplied. For example, referring to FIG. 6, a score for a combination of the attribute expression of “battery” and the attribute value of “long-lasting” is 0.3*0.2=0.06.

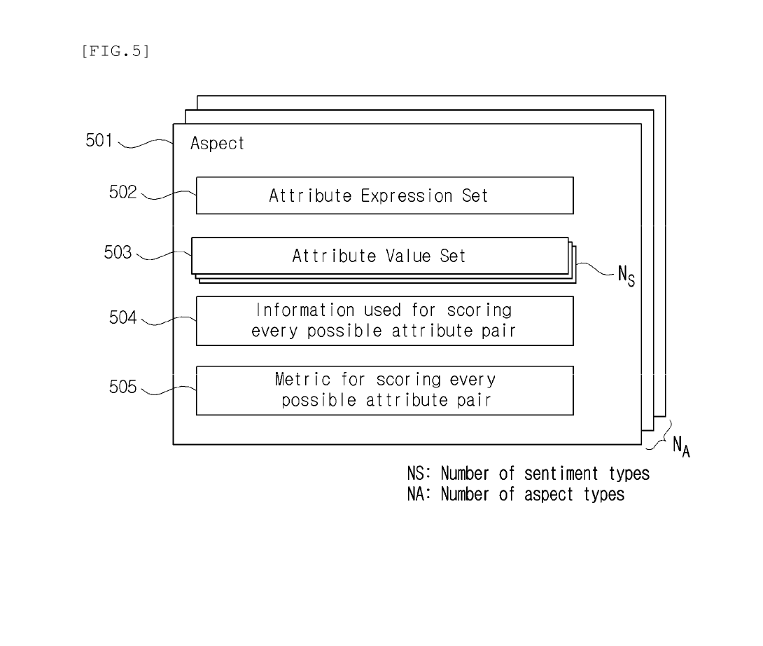

FIG. 5 illustrates one form of a learning result for a sentiment analysis according to an exemplary embodiment of the present invention.

As illustrated in FIG. 5, a form of a learning result is illustrated, and there is an N_{S} type of sentiment and an N_{A} type of attribute.

That is, one attribute expression set 502 and the N_{S} number of attribute value sets 503 for each attribute 501 are learned, and information 504 assigned to a predetermined combination, that is, the attribute pair, and a metric 505 based on which a point may be calculated by using the information assigned to the attribute pair are learned.

FIG. 6 illustrates another form of a learning result for a sentiment analysis according to an exemplary embodiment of the present invention.

As illustrated in FIG. 6, a learning result for an attribute, for example, “battery life”, is illustrated. One attribute expression set 601 and attribute value sets 602 and 603 for two types of sentiments, that is, a positive sentiment and a negative sentiment, are learned. This is one example, and the number does not need to be essentially learned for each expression, and the learning result may be different according to a learning method and a point calculation metric.

A method of analyzing a sentiment by using the learning result will be described below.

For example, it is determined that a combination of a predetermined expression included in the attribute expression set and a predetermined expression included in a positive attribute value set always represents “positive” for the attribute of “battery life”. On the contrary, it is determined that a combination of a predetermined expression included in the attribute expression set and a predetermined expression included in a negative attribute value set always represents “negative” for the attribute of “battery life”.

The attribute of “battery life” may be determined as “positive” by a total of 16 combinations.

The attribute may be determined by a method using a point for the determination obtained by multiplying the numbers of the two expressions included in the combination. For example, the attribute of “battery life” may be determined as “positive” based on a point (0.30*0.20) of 0.06 for the expression of “the battery is long-lasting”.

Various point calculation methods may be used in addition to the aforementioned method of calculating the point.

The search unit 123 may search for a sentence or writing including a target keyword. In this case, the search unit 123 searches for a sentence or writing including a target keyword in a portal site or social media.

The extraction unit 124 may extract an attribution expression and attribute values included in the searched sentence or writing.

The analysis unit 126 may calculate a sentiment analysis result for the target keyword based on the extracted attribute expression and attribute values, and the previously learned leaning result, and provide the user terminal 110 with the calculated sentiment analysis result.

To describe a process of the sentiment analysis in detail, the sentiment is determined by performing a process on each attribute pair as below. First, the analysis unit 126 may search for an attribute including an attribute expression of an attribute pair in a learning result. That is, the analysis unit 126 identifies whether an attribute expression of a current attribute pair is present in an attribute expression set for each attribute of the learning result.

When the attribute expression of the current attribute pair is present as a result of the identification, the analysis unit 126 may identify whether an attribute value of the current attribute pair is included in attribute value sets for each sentiment of the attribute.

When the attribute value of the current attribute pair is present as the result of the identification, the analysis unit 126 may determine a corresponding attribute and a corresponding sentiment as a sentiment of the current attribute pair, and calculate a point for the determined sentiment.

The analysis unit 126 may calculate a sentiment analysis result for the sentiment analysis for each attribute by processing the determined result to various forms. As one example, the sentiment analysis result may contain information on the attribute pair in which the sentiment is recognized, and the attribute pair may contain information on a corresponding part in the actual text. As another example, when a point of a certain attribute pair in which the sentiment is determined does not exceed a predetermined threshold, the sentiment analysis result may show that there is no sentiment for the corresponding text or not suggest a sentiment for the corresponding text.

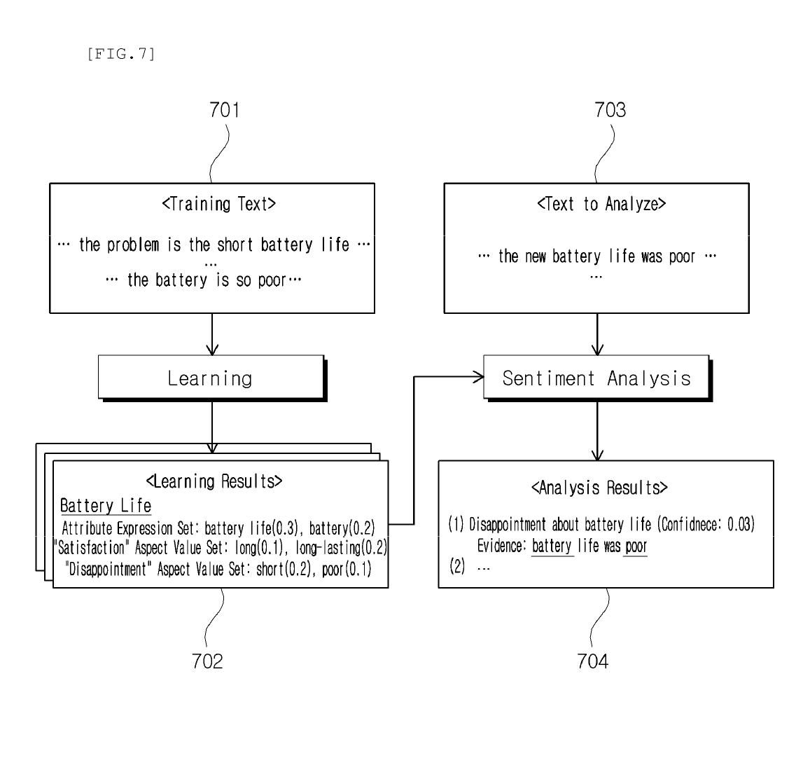

FIG. 7 is a diagram for describing a process of a sentiment analysis according to an exemplary embodiment of the present invention.

As illustrated in FIG. 7, a learning result 702 is generated by learning each attribute from a previously collected learning text 701, and then an analysis result 704 is generated by analyzing a text 702 to be newly analyzed by using the learning result 702.

For example, a sentiment for an expression of “the new battery life was poor” is determined by using the learning result, and it is determined that a “disappointment” sentiment is exhibited for the attribute of “battery life” as a result of the determination, and reliability for the determination is calculated as 0.03 based on the 0.3 of “battery” in the attribute expression set and 0.1 of “poor” in a disappointment attribute value set.

The text that is a basis of the determination is additionally suggested together.

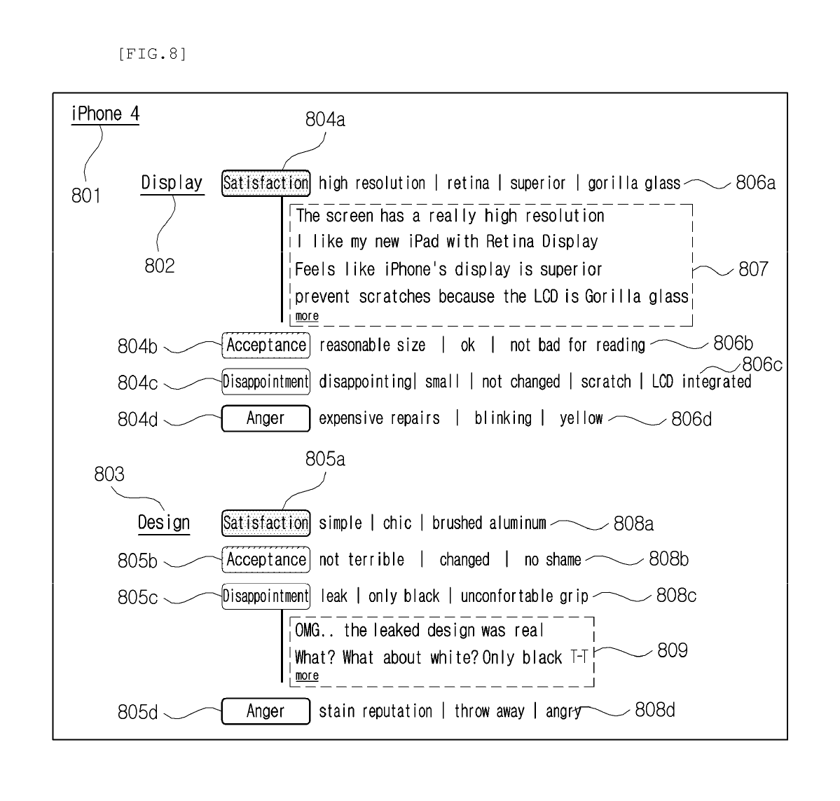

FIG. 8 illustrates a screen displaying a sentiment analysis result according to an exemplary embodiment of the present invention.

As illustrated in FIG. 8, an example of a result of an analysis of a text for “iPhone 4” is illustrated. Results for a display 802 and a design 803 among attributes of a target keyword 801 of iPhone 4 are represented.

The sentiment includes four types of satisfaction 804a and 805a, acceptance (804b and 805b), disappointment (804c and 805c), and anger (804d and 805d) for the display 802 and the design 803, respectively, and is displayed through color boxes.

Examples of attribute values 806a, 806b, 806c, and 806d used for representing the sentiment for a corresponding attribute are listed at the right side of the sentiment box of the display 802. A case of “satisfaction” for the “display” means that the expression 806a, such as “high resolution” and “retina”, is used.

When the user clicks the sentiment box, the user may also view the actual text. When the user clicks the satisfaction 804a in order to express the satisfaction 804a for the display 802, the actual text 807 is displayed, and the actual text represents that the expressions 807, such as “The screen has a really high resolution” and “I like my new iPad with Retina Display” are used. Even though the expression of the “display” is not directly used in the text, the sentiment analysis is successfully performed by using a combination of the attribute expressions, the “screen”, the “display”, and the “LCD”, and the attribute value through the analysis method suggested in the present invention.

Similarly, examples of attribute values 807a, 807b, 807c, and 807d used for representing the sentiment for a corresponding attribute are listed at the right side of the sentiment box of the design 803.

When the user clicks the sentiment box, the user may also view the actual text. When the user clicks the disappointment 805c for representing the disappointment 805c for the design 803, an actual text 809 is displayed.

In this case, a color, an underline, a highlight, and the like are differently applied to the attribute expressions and the attribute values serving as a determination reference for analyzing the sentiment so that the attribute expressions and the attribute values are displayed so as to be discriminated within the text.

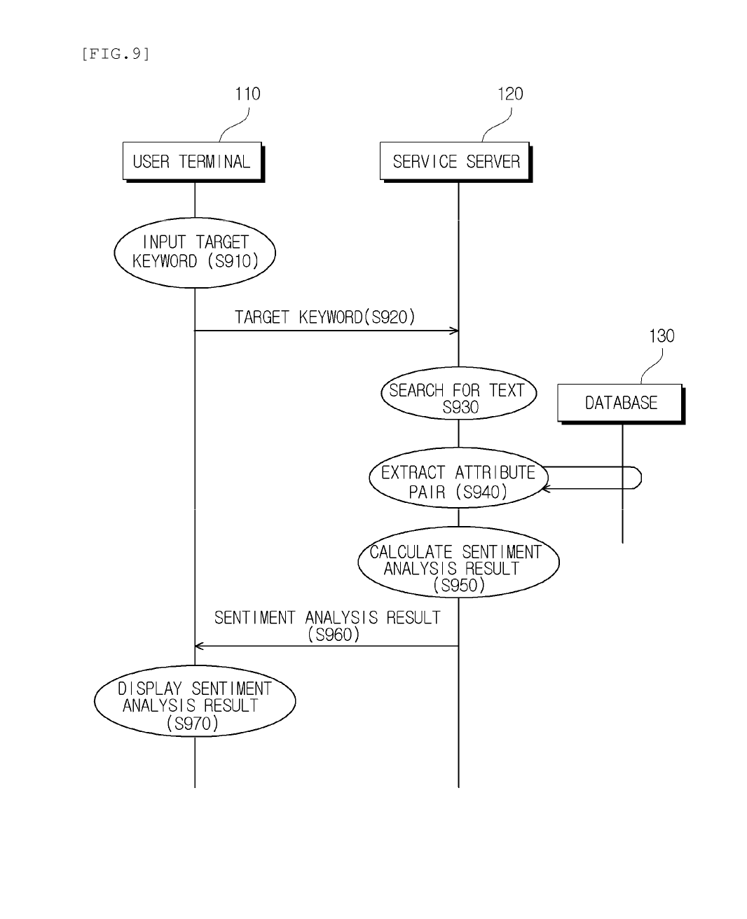

FIG. 9 illustrates a method of providing a sentiment analysis result according to an exemplary embodiment of the present invention.

As illustrated in FIG. 9, when the user terminal 110 receives a target keyword for a target, for which a sentiment is desired to be analyzed, from a user (S910), the user terminal 110 may provide the received target keyword and request a sentiment analysis result for the provided target keyword to the service server 120 (S920).

Next, when the service server 120 receives the target keyword, the service server 120 may search for a text, such as a sentence or writing, including the received target keyword (S930).

Next, the service server 120 may extract an attribute pair of an attribute expression and an attribute value for each attribute from the searched text (S940). That is, the service server 120 extracts the attribute pair of the attribute expression and the attribute value for each preset attribute of the target keyword from the searched text based on the previously learned learning result, and the attribute of the target keyword is previously set through learning.

Next, the service server may calculate a sentiment analysis result for the target keyword based on the extracted attribute pair (S950), and provide the user terminal with the calculated sentiment analysis result (S960).

Next, the user terminal may receive the sentiment analysis result for each attribute from the service server, and display the received sentiment analysis result for each attribute (S970).

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for providing a sentiment analysis result based on a text, the apparatus comprising:
an input unit configured to receive a keyword for a target, for which a sentiment is desired to be analyzed, from a user;
a control unit configured to request a sentiment analysis for the received keyword to a service server and receive a sentiment analysis result as a result of the request;
a display unit configured to display an attribute for the target according to the received sentiment analysis result, and display a text corresponding to an attribute value for each displayed attribute; and
a storage unit configured to store the received sentiment analysis result,
wherein the attribute is a detailed item for evaluating the target of the sentiment or expressing the sentiment, and the attribute value is an expression for evaluating the attribute or representing the sentiment for the attribute.

2. The apparatus of claim 1, wherein the display unit displays the attribute for the target, displays a plurality of sentiments for each displayed attribute, and displays a text corresponding to the attribute value for each displayed sentiment.

3. The apparatus of claim 2, wherein the display unit displays a text corresponding to the attribute value for each sentiment, and displays attribute expressions and attribute values serving as a determination reference for analyzing the sentiment while emphasizing the attribute expressions and the attribute values by using at least one of a color, an underline, and a highlight so that the attribute expressions and the attribute values are discriminated within the text.

4. The apparatus of claim 1, wherein the display unit displays a text corresponding to the attribution value for each sentiment, and calculates a point by using a numerical value previously assigned to each of the attribution expressions and the attribute values serving as the determination reference for analyzing the sentiment, and determines a corresponding sentiment to which each of the texts belongs based on the calculated point.

5. A system for providing a sentiment analysis result based on a text, the system comprising:
a service server configured to search for a text including a keyword for a target, for which a sentiment is desired to be analyzed, received from a user terminal, calculate a sentiment analysis result for each attribute for the target from the searched text based on a previously learned learning result, and provide the calculated sentiment analysis result to the user terminal; and
a database configured to store a learning result including an attribute expression set and an attribution value set calculated from a previously collected learning text,
wherein the attribute is a detailed item for evaluating the target of the sentiment or expressing the sentiment, the attribute expression set represents a set of attribute expressions which are detailed expressions used for indicating the attribute, and the attribute value set represents a set of attribute values which are expressions for evaluating the attribute or representing a sentiment for the attribute.

6. The system of claim 5, wherein the service server comprises:
a search unit configured to search for a text including the keyword for the target for which the sentiment is desired to be analyzed;
an extraction unit configured to extract an attribute expression and attribute values from the text based on the previously learned learning result; and
an analysis unit configured to calculate a sentiment analysis result for the keyword based on the extracted attribute expression and attribute values, and the learning result, and provide the user terminal with the calculated sentiment analysis result.

7. The system of claim 5, wherein the analysis unit identifies whether the extracted attribute expression and attribute values are included in the attribute expression set and the attribute value set of the learning result, and determines an attribute and a sentiment corresponding to the attribute expression set and the attribute value set of the learning result as the attribute and the sentiment of the extracted attribute expression and attribute values according to a result of the identification.

8. The system of claim 5, wherein the service server comprises:
a collection unit configured to previously collect a plurality of learning texts for learning;
an extraction unit configured to extract an attribute expression and attribute values included in the previously collected learning text; and
a learning unit configured to perform learning for the analysis of the sentiment by using the extracted attribute expression and attribute value, and generate the learning result with a result of the learning.

9. The system of claim 5, wherein the learning result includes a set of the attribution expressions, a set of the attribute values, a numerical value assigned to the attribute expression and the attribute value of every combinable attribute pair, and a method capable of calculating a point by using a numerical value assigned to the combinable attribute expression and attribute value.

10. A method of providing a sentiment analysis result based on a text, the method comprising:
receiving a keyword for a target for which a sentiment is desired to be analyzed from a user;
requesting a sentiment analysis for the received keyword to a service server and receiving a sentiment analysis result as a result of the request;
displaying an attribute for the target according to the received sentiment analysis result, and displaying a text corresponding to an attribute value for each displayed attribute; and
storing the received sentiment analysis result,
wherein the attribute is a detailed item for evaluating the target of the sentiment or expressing the sentiment, and the attribute value is an expression for evaluating the attribute or representing the sentiment for the attribute.

11. The method of claim 10, wherein the displaying includes displaying the attribute for the target and displaying a plurality of sentiments for each displayed attribute, and displaying a text corresponding to the attribute value for each displayed sentiment.

12. The method of claim 11, wherein the displaying includes displaying a text corresponding to the attribute value for each sentiment, and displaying attribute expressions and attribute values serving as a determination reference for analyzing the sentiment while emphasizing the attribute expressions and the attribute values by using at least one of a color, an underline, and a highlight so that the attribute expressions and the attribute values are discriminated within the text.

13. The method of claim 10, wherein the displaying includes displaying a text corresponding to the attribution value for each sentiment, and calculating a point by using a numerical value previously assigned to each of the attribution expressions and the attribute values serving as the determination reference for analyzing the sentiment, and determining a corresponding sentiment to which each of the texts belongs based on the calculated point.

14. A method of providing a sentiment analysis result based on a text, the method comprising:
storing a learning result including an attribute expression set and an attribution value set calculated from a previously collected learning text;
searching for a text including a keyword for a target, for which a sentiment is desired to be analyzed, received from a user terminal; and
calculating a sentiment analysis result for each attribute for the target from the searched text based on the previously learned learning result and providing the user terminal with the calculated sentiment analysis result,
wherein the attribute is a detailed item for evaluating the target of the sentiment or expressing the sentiment, the attribute expression set represents a set of attribute expressions which are detailed expressions used for indicating the attribute, and the attribute value set represents a set of attribute values which are expressions for evaluating the attribute or representing a sentiment for the attribute.

15. The method of claim 14, wherein the providing includes extracting an attribute expression and attribute values from the text based on the previously learned learning result, and calculating a sentiment analysis result for the keyword based on the extracted attribute expression and attribute values, and the learning result, and providing the user terminal with the calculated sentiment analysis result.

16. The method of claim 14, wherein the providing includes identifying whether the extracted attribute expression and attribute values are included in the attribute expression set and the attribute value set of the learning result, and determining an attribute and a sentiment corresponding to the attribute expression set and the attribute value set of the learning result as the attribute and the sentiment of the extracted attribute expression and attribute values as a result of the identification.

17. The method of claim 14, wherein the storing includes previously collecting a plurality of learning texts for learning and extracting an attribute expression and attribute values included in the previously collected learning text, and performing learning for the analysis of the sentiment by using the extracted attribute expression and attribute value, generating the learning result with a result of the learning, and storing the generated learning result.

18. The method of claim 14, wherein the learning result includes a set of the attribution expressions, a set of the attribute values, a numerical value assigned to the attribute expression and the attribute value of every combinable attribute pair, and a method capable of calculating a point by using a numerical value assigned to the combinable attribute expression and attribute value.
